(19) United States
(12) Patent Application Publication
(10) Pub. No.: US 2026/0113583 A1
(43) Pub. Date: Apr. 23, 2026

(54) CLASSIFYING HEARING DEVICE RECEIVER BASED ON FREQUENCY DEPENDENT ELECTRICAL CHARACTERISTICS

(71) Applicant: Starkey Laboratories, Inc., Eden Prairie, MN (US)

(72) Inventors: Anthony Mangio, Eden Prairie, MN (US); John Bradley Etherington, Eagan, MN (US)

(21) Appl. No.: 19/349,292

(22) Filed: Oct. 3, 2025

Related U.S. Application Data
(60) Provisional application No. 63/710,266, filed on Oct. 22, 2024.

(51) Int. Cl. H04R 29/00; H04R 1/10

(52) U.S. Cl. CPC H04R 29/001; H04R 1/1041; H04R 1/1025

(57) ABSTRACT

An ear-wearable device includes receiver that outputs sound into an ear canal of a user in response to an electrical input signal. The device includes one or more electrical components separate from and electrically coupled to the receiver. A processor is configured to perform a measurement process involving sending an audio input signal to the receiver and measuring a set of frequency dependent electrical characteristics of the one or more electrical components in response to the audio input signal. The set of frequency dependent electrical characteristics are input into a machine learning model to determine an output. A classification of the receiver is determined based on the output of the machine learning model. The classification of the receiver is used to set an operational parameter of the ear-wearable device.

This application claims the benefit of U.S. Provisional Application No. 63/710,266, filed Oct. 22, 2024, the disclosure of which is incorporated by reference herein in its entirety.

### SUMMARY

This application relates generally to ear-level electronic systems and devices, including hearing aids, personal amplification devices, and hearables. In one embodiment, an ear-wearable device includes receiver that outputs sound into an ear canal of a user in response to an electrical input signal. The device includes one or more electrical components separate from and electrically coupled to the receiver. A processor is configured to perform a measurement process involving sending an audio input signal to the receiver and measuring a set of frequency dependent electrical characteristics of the one or more electrical components in response to the audio input signal. The set of frequency dependent electrical characteristics are input into a machine learning model to determine an output. A classification of the receiver is determined based on the output of the machine learning model. The classification of the receiver is used to set an operational parameter of the ear-wearable device. In another embodiment, a method of processing sound in an ear-wearable

device involves sending an audio input signal to a receiver of the ear-wearable device and measuring a set of frequency dependent electrical characteristics of one or more electrical components in response to the audio input signal. The one or more electrical components are separate from and electrically coupled to the receiver. The set of frequency dependent electrical characteristics are input into a machine learning model to determine an output. A classification of the receiver is determined based on the output of the machine learning model. The classification of the receiver is used to set an operational parameter of the ear-wearable device. The figures and the detailed description below more particularly exemplify illustrative embodiments.

### BRIEF DESCRIPTION OF THE DRAWINGS

The discussion below makes reference to the following figures.

FIG. 1 is an illustration of a processing path of an ear-wearable device according to an example embodiment;

FIG. 2 is a block diagram showing a machine-learning-based sound processor according to an example embodiment;

FIG. 3 is a graph of different receiver impedance responses according to example embodiments;

FIG. 4 is a table shown example machine learning inputs according to an example embodiment;

FIG. 5 is a table showing an example machine learning classification output according to an example embodiment;

FIGS. 6 and 7 are flowcharts a methods according to an example embodiments; and

FIG. 8 is a block diagram of a hearing device and system according to an example embodiment.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments disclosed herein are directed to an ear-worn or ear-level electronic hearing device. Such a device may include cochlear implants and bone conduction devices, without departing from the scope of this disclosure. The devices depicted in the figures are intended to demonstrate the subject matter, but not in a limited, exhaustive, or exclusive sense. Ear-worn electronic devices (also referred to interchangeably herein as “hearing aids (HA),” “hearing devices,” “ear-wearable devices,” and “audio wearables (AW)”), such as hearables (e.g., wearable earphones, ear monitors, and earbuds), hearing aids, hearing instruments, and hearing assistance devices, typically include an enclosure, such as a housing or shell, within which internal components are mounted or disposed.

Embodiments described herein include features that provide automatic identification of a type of receiver (also referred to as a loudspeaker) currently installed in a hearing device. Generally, receivers can be user-replaceable in the event of a malfunction or failure of the receiver, for example. Other reasons to make receivers replaceable is to adapt to user changes, e.g., progression of hearing loss, discomfort with the current receiver, etc.

If a receiver is changed out, the audio processing electronics of the hearing device will typically have to change internal parameters if a new receiver has different properties than the existing receiver. Those internal parameters may include power output parameters (e.g., voltage output), frequency response, phase response, etc., due to different electrical characteristics of different receivers.

In order to identify and correctly configure a hearing device for a particular receiver, the receiver may currently be configured to communicate some information to the device electronics. For example, the receiver may include a small amount of memory that identifies the receiver, e.g., based on a model number, general classification, or the like. Such data can be transmitted over a data bus, e.g., inter-integrated circuit (I2C) bus. In other embodiments, a resistor network can be used to provide a similar function, e.g., setting resistance across one or more input-output pins to encode the receiver identification data.

While the use of memory or resistors to identify a receiver is effective, it adds costs. Not only do the memory or resistors themselves add to the cost of the receiver, additional conductors and/or communications interfaces add to the cost of both the receiver and the main board of the hearing device. Given the cost-competitiveness of the hearing aid market, it is desirable to reduce costs involved in receiver identification.

In embodiments described herein, one or more signals are sent to the receiver via its sound input channels. The inherent electrical characteristics of the receiver will affect the hearing device electronics in a specific way depending on the type and/or configuration of the receiver. The associated effects can be gathered as sensor information by existing sensors on the device. The sensor information (e.g., system voltage, system current, microphone signals, etc.) can be used by a machine learning algorithm to classify the receiver used.

A machine learning algorithm allows for the hearing device to identify the type of receiver being used by the hearing aid without any external memory or circuitry being used. This arrangement reduces the total overall cost of manufacturing a hearing device. For example, receiver-in-canal (RIC) assemblies will not need electrically-erasable, programmable read-only memory (EEPROM) and associated electrostatic discharge (ESD) protection components. This arrangement can be used on any hearing device with sufficient computing resources to run a small machine-learning model, e.g., a feedforward, neural network classifier, and can reduce component count and manufacturing cost.

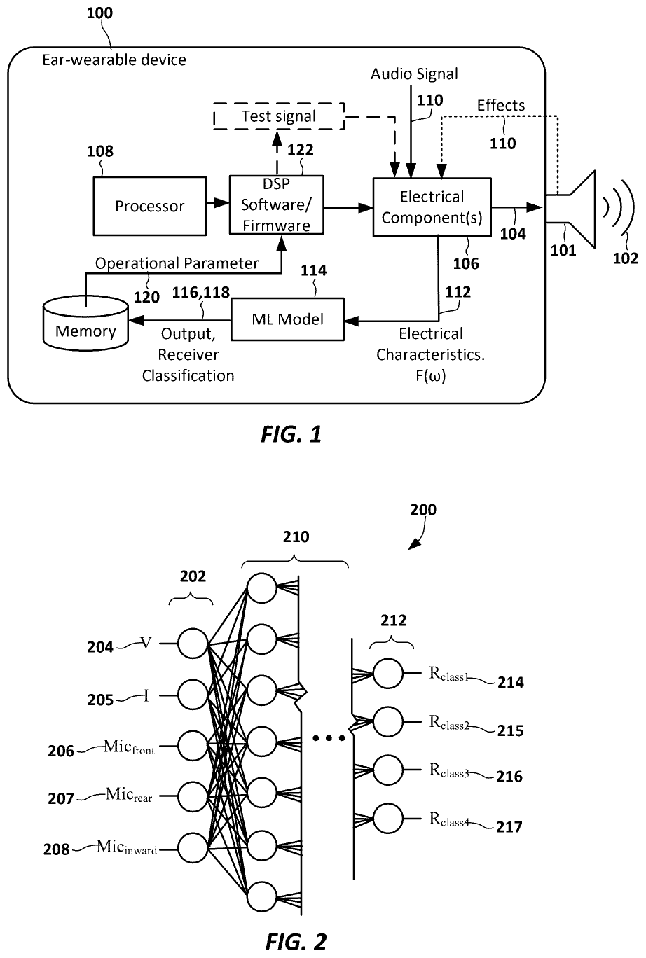

In FIG. 1, a block diagram illustrates an ear-wearable device 100 according to an example embodiment. The device 100 includes a receiver 101 that outputs sound 102 into an ear canal in response to an electrical input signal 104. Note that the receiver 101 is changeably attached to the car-wearable device 100, thus it is shown outside the box that defines the device 100. In the attached state, the receiver 101 is considered as part of the car-wearable device 100, because it is electrically and (typically) mechanically connected.

The car-wearable device 100 includes one or more electrical components 106 separate from and electrically coupled to the receiver 101. These components 106 are operable to detect effects 110 of the receiver 101 on the device 100, e.g., provide measurements such as current, voltage, temperature, sound, and the like while the receiver 101 is being driven by a signal. For example, a device battery and/or power regulation components on a main circuit board may have a digital interface to read current and voltage. Other electrical devices (e.g., power amplifiers) may have similar capability. Other components 106 include microphones that can measure sound generated by the receiver 101, accelerometers that can measure vibrations from the receiver 101, etc.

A processor 108 is operably coupled to the receiver 101 and the one or more electrical components and configured to perform a measurement process involving sending an audio input signal 104 to the receiver and measuring a set of frequency dependent electrical characteristics 112 of the one or more electrical components 106 in response to the audio input signal 104. The audio signal 104 may include any combination of test tone, random noise, ambient sound measured from a microphone (not shown), etc. The receiver 101, due to its inherent electrical characteristics such as its impedance, will cause effects 110 to impact the electrical components 106, which are measured via the electrical characteristics 112.

The set of frequency dependent electrical characteristics 112 are input to a machine learning model 114 to determine an output 116. The output 116 of the machine learning model provides or facilitates determining a classification 118 of the receiver 101. The classification 118 of the receiver 101 is used to set an operational parameter 120 of the car-wearable device 100. The operational parameter 120 can be used by software/firmware 122 of the car-wearable device 100 to set, for example, an amplifier/receiver gain, an equalization setting, output compression limiting, etc.

The term “machine-learning” can refer to a number of algorithms that train a data structure on a set of data and adapt a state of the structure based on the training to provide a specific output. Machine learning classifiers include, but aren't limited to, feedforward neural networks, recurrent neural networks, convolutional neural networks, logistic regression, K-nearest neighbors, support vector machine (SVM), Kernal SVM, naïve Bayes, and decision tree classification. In FIG. 2, a diagram shows a neural network 200 configured as a classifier according to an example embodiment. This neural network 200 is a multilayer perceptron (MLP), which is often used as a feedforward, machine learning classifier.

The neural network 200 includes an input layer 202 which receive numerical data representing frequency dependent electrical characteristics. Examples of these characteristic data inputs are a voltage 204, a current 205, and signal levels 206-208 of three different microphones. The inputs 204-208 are frequency dependent, therefore each input 204-208 may include a vector, with each element of the vector representing the value measured across a corresponding frequency range. These frequency dependent values may be obtained, for example, by performing a Fourier transform (FFT) on time domain data of each measurement while a test tone or other signal is played through the receiver. In other embodiments, the machine learning model may include a recurrent neural network (RNN) that performs classification directly one time domain data of the input signals, therefore does not need the input data to be transformed to the frequency domain.

The nodes of the input layer 202 are fully connected to one or more hidden layers 210. Each node of the hidden layer performs an activation function on the combination of separate inputs from the input layer 202, and the outputs of the first hidden layer 210 may be coupled to additional hidden layers (not shown). A last one of the hidden layers 210 is fully connected to an output layer 212, which in this example is trained to distinguish between four different receiver classifications 214-217. The illustrated network 200 is generally referred to as a deep neural network (DNN), in that it contains one or more hidden layers 210 between the input and output.

The network 200 is trained, e.g., via backpropagation with gradient descent, to minimize an error between predicted classifications of a training data set and pre-assigned “ground truth” classifications labels associated with the training data. This is referred to as supervised training, wherein a pre-labeled set of data is used for training. In unsupervised training, a machine learning model (e.g., SVM) finds its own groupings of output classifications based on characteristics of the data learned though training. Unsupervised learning may also be used as part of the machine learning model, e.g., to find a reduced characterization of the measurements provided to input layer 202. Once trained, the state data of the network 200 (e.g., node weights and biases of the hidden and output layers) can be used in a hearing device to run a similarly configured network that provides the desired classifications. After a well-performing model is trained, it could be trimmed and quantized to fit within the hearing device memory.

In Table 1 below, hyper-parameters of a neural network as shown in FIG. 2 are provided. A neural network with similar characteristics can be implemented in other ways as described elsewhere herein and the illustrated example is not meant to be limiting. For example, not all of the inputs need to be provided over the same M-frequency buckets. If the measured values of voltage at center frequency Fₙ do not show significant variation across all receivers, these can be removed from the inputs, thereby reducing the size of the network and associated computing resources need to run the model. In other words, the input vectors 204-208 do not need to be of the same dimension, nor do the indices of different vectors need to correspond to the same center frequencies.

TABLE 1

| Deep Neural Network | |
|---|---|
| Parameter | Value |
| Network Topology | Multilayer perceptron, N-input vectors, each |
| | vector having M-elements corresponding to |
| | M-different frequency buckets. K-different |
| | classifications in output layer, two or more |
| | hidden layers of size ≥ M × N. Output layer |
| | normalized with a softmax function. |
| Data format for inputs | Inputs are extracted from the digitized SoC |
| | and microphone signals. These inputs can be |
| | converted to the frequency dependent data |
| | using techniques such as the Fast Fourier |
| | Transform (FFT). |
| Activation Function | ReLu activation function for all layers |
| Learning Paradigm | Supervised learning using backpropagation |
| | with gradient descent |
| Training Dataset | Measurements taken with a population of |
| | devices randomly paired with different |
| | receivers to obtain a large number (>1000) of |
| | labeled training samples |
| Cost Function | Mean squared error loss to minimize error |
| | between the correct receiver classification |
| | and the neural network result |
| Starting Values | Random values |

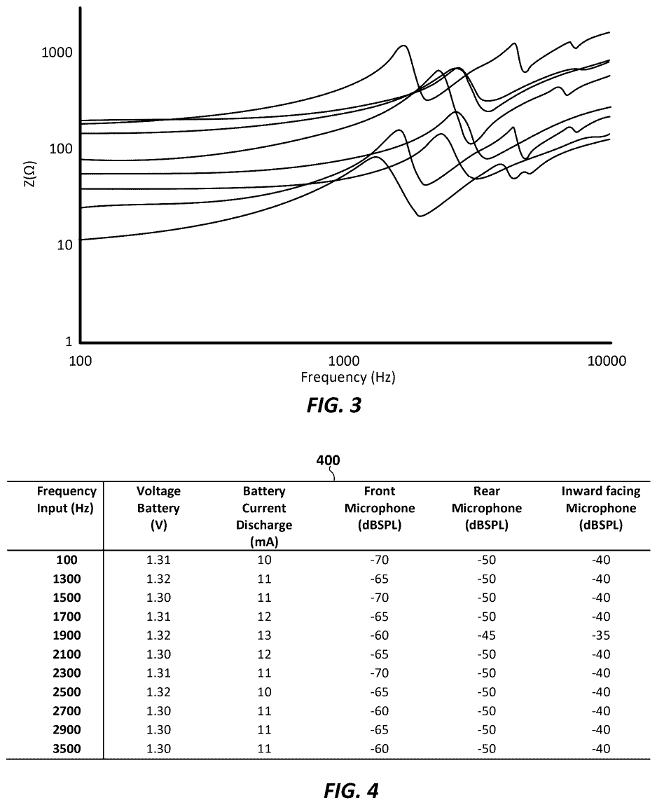

In FIG. 3, a plot illustrates measured impedance as a function of frequency for a number of different receivers. Generally, these differences in impedance will result in measurably different performance of characteristics such as amplifier voltage and current, as well as differing sound pressure levels over various frequencies. In FIG. 4, a table 400 shows an example of measured values for a particular receiver that may be used to form training and operational data. Note that the eleven frequencies in the first column of the table are not evenly distributed either linearly or logarithmically, although they may be in some cases. The selection of appropriate frequencies for characterizing measurements for a population of device configurations may be determined through unsupervised machine learning.

The second through sixth columns of table 400 could be used to form five, 11-dimensional input vectors to a machine learning model. As noted above, not all of the vectors need to have the same size, e.g., the size of some vectors can be reduced if the measurements at some frequencies provide little or no differentiation between the tested receivers. Similarly, different measurement vectors may select different frequencies to characterize, e.g., voltage and current may be selected at different frequencies than the microphone sound pressure level (SPL).

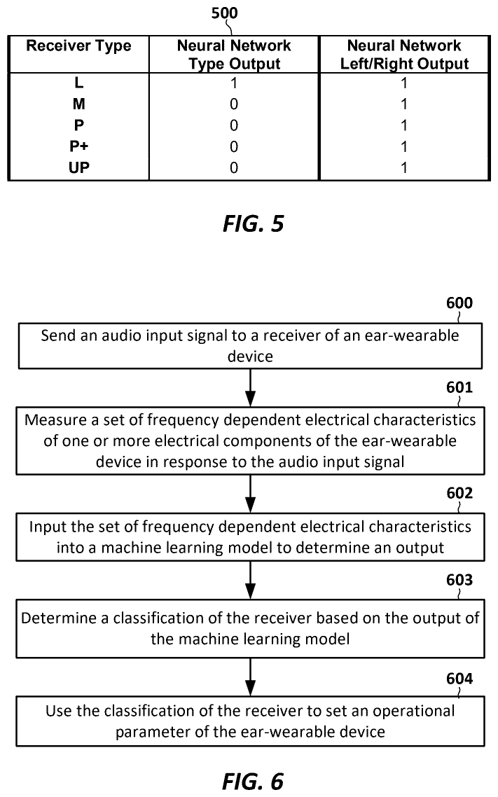

In FIG. 5, a table 500 shows output provided by a machine-learning model according to an example embodiment. The first column indicates a type of receiver, e.g., L=low output, which indicates an amount of nominal gain to achieve a reference output from the receiver. The second column is “1” if the class is detected, and “0” if not detected. In the second column this example, the “1” in the first row and “0” in the other rows indicates the receiver corresponds to the “L” type. Any classification scheme could be used for receiver type, e.g., a unique identifier of a class of the receiver, a model number of the receiver, a version of the receiver, etc. Each value in the second column could be provided by a different node of the output layer 212 in FIG. 2.

The third column of the table 500 represents an left/right output from the model, e.g., provided by a single node of the output layer 212 in FIG. 2. The left/right indicator is a characteristic that is independent of the type of receiver, e.g., receiver type can be changed without changing left/right location, and vice versa. The third column indicates whether the receiver is in a left or right ear position, e.g., left=“0” and right=“1.” In this example, all the rows in the third column would be the same regardless of what is in the second column. The value in the third column could be read from a single node of the output layer, so that a neural network with this example of classification output would have six output nodes, five for receiver type and one for receiver placement.

Note that the output values of a neural network may be floating point numbers, e.g., in a range between “0” and “1” inclusive. Therefore using real world inputs, the machine learning outputs may not always clearly indicate a classification as shown in this example. Various schemes known in the art may be used to deal with ambiguous outputs, e.g., assigning a “1” to the maximum value on the second row and “0” to all others, with a random choice for “1” in the case of a tie. Similarly, the left/right could be chosen based on whether the output is above or below 0.5, with random assignment if the output is exactly 0.5.

Generally, the embodiments described herein may send a well-defined, known input (or set of inputs) to the receiver. Such input may be a test tone, multiple tones, spectrally balanced noise (e.g., white noise), etc. In some case, the inputs will only be sent when the hearing device is out of car, e.g., in a charging stand, carrying case, or the like. In other cases, the input may be sent while the device is in the user's ear. This can be done discreetly, for example, by using specially crafted status tones that are occasionally emitted by the device during normal use. An example of the use of operational tones to measure device characteristics is described in U.S. Provisional Application 63/604,360, filed Nov. 30, 2023. In other cases, the machine learning model may be trained on ambient noise, such that it may be possible to classify the receiver in-ear without using specially crafted test audio.

While the input signal is being sent to the receiver, the system response is measured by the hearing device (e.g., voltage, current, and audio). The system response may be processed, e.g., converted to a frequency domain representation, scaled, averaged, etc., to provide a desired form and reduce the effects of error/noise. The processed response is fed into a classification machine learning model that detects which receiver type is being used. To train the neural network a high number of (e.g., 2000-4000) training examples with an equal amount of each receiver type could be used to ensure no biasing towards a receiver type.

In order to implement a machine learning solution for receiver identification, the existing sensors on the hearing device could be used with no additional sensor or sensing lines added to directly monitor signals from the receiver. The audio output and usage of current and voltage during the tone generation event will allow for receiver identification. Additionally, hearing aids using the more advanced power management integrated circuits (PMIC) can vary the voltage across the output driver for the receiver allowing for another axis to be added to the input matrix space.

To ensure repeatable acoustic performance, a charging cradle/case can be used to hold the hearing device during the receiver measurement. The charger or case provides a known and relatively static acoustic environment. During the classification test, the hearing device may disable the charging path between the charging case and the hearing device. This will help ensure that the charging circuitry does not influence the test results. The charging path disabling may be done by the hearing device itself and/or via a communication to the charging case.

In some cases, the hearing device may perform an initial test outside the car (e.g., inside a charging case) but may also be able to validate after being placed inside the car canal. This validation may be performed regularly to see if any anomalies are noted, or to detect situations where the user swapped out the receiver without subsequently pairing it in the charger. To ensure that the hearing device continues to correctly identify the receiver during use, an inward facing microphone can be used to determine the sound pressure within the car canal. This can be compared against a baseline, for example, to see if the receiver was swapped without running the receiver identification process, e.g., placing back in charger. If a different receiver is detected, or if an anomalous result is detected, the user may be instructed to place the hearing device back into the case to perform the complete identification check.

The trained machine learning model data can be provided to the hearing device directly, e.g., at the factory, via an audiologist. In some embodiments, the user may be able to perform an initial and/or subsequent loading of trained machine learning model data, e.g., by downloading from the Internet to a secondary device (e.g., computer, mobile phone, etc.) then transferring from the secondary device to the hearing device. The trained machine learning model data can be temporarily transferred from the secondary device to the hearing aid as needed, and later deleted from the hearing device to save memory. In some embodiments, the machine learning model can be run on the hearing device, mobile phone, accessory (charger), computer, remote server, or any other secondary device. For example, the hearing device can gather data describing the electrical characteristics and transmit the data to the secondary device for processing, after which the secondary device sends back the receiver classification. In any of these examples, the classification of the receiver determined by the machine learning model is stored into the memory as part of the measurement process and remains in the memory after the measurement process.

In FIG. 6, a flowchart illustrates a method of processing sound in an car-wearable device according to an example embodiment. The method may be processor-implemented in an car-wearable device. The method involves sending 600 an audio input signal to a receiver of the car-wearable device. A set of frequency dependent electrical characteristics of one or more electrical components is measured 601 in response to the audio input signal. The one or more electrical components are separate from and electrically coupled to the receiver. The set of frequency dependent electrical characteristics are input 602 into a machine learning model to determine an output. The machine learning model may run on the car-wearable device or on a secondary device. A classification of the receiver is determined 603 based on the output of the machine learning model. The classification of the receiver is used 604 to set an operational parameter of the ear-wearable device.

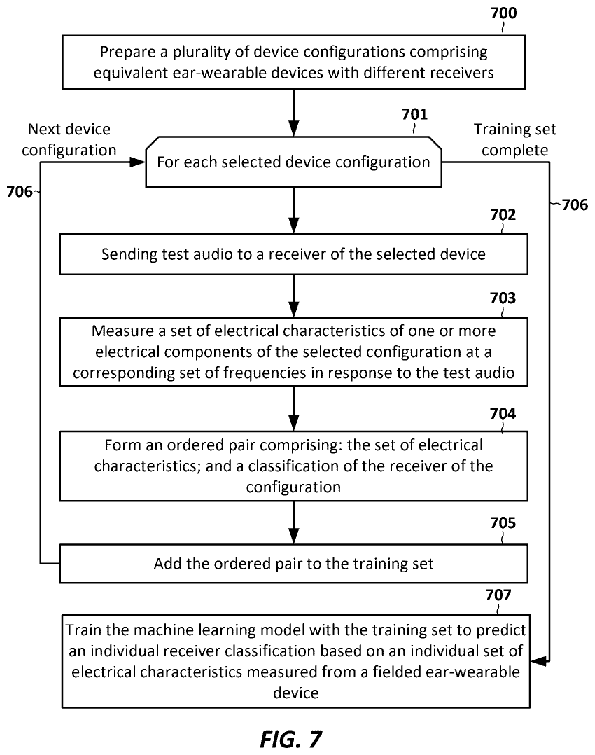

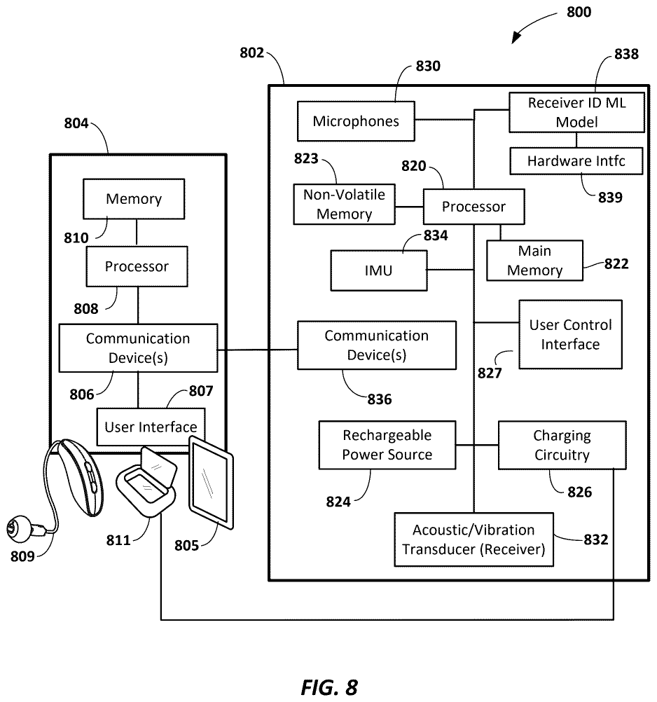

In FIG. 7, a flowchart shows method of training a machine learning model for using in an ear-wearable device according to an example embodiment. The method involves preparing 700 a plurality of device configurations comprising equivalent ear-wearable devices that employ different receivers. The collecting of the training data involves iterations indicated by loop limit 701. The method involves, for each selected device configuration, sending 702 test audio to a receiver of the selected device configuration. A set of electrical characteristics of one or more electrical components of the selected hearing device configuration is measured 703 at a corresponding set of frequencies in response to the test audio. The one or more electrical components are separate from and electrically coupled to the receiver;

The iterations further involve forming 704 an ordered pair that includes: the set of electrical characteristics; and a classification of the receiver. The ordered pair is added 705 to the training set, after which the iterations repeat via path 706. The iterations complete once enough examples are measured, after which the training set is complete as indicated by line 706. The machine learning model is then trained 707 with the training set (e.g., supervised learning with backpropagation) to predict an individual receiver classification based on an individual set of electrical characteristics measured from a fielded ear-wearable device.

In FIG. 8, a block diagram illustrates a system and ear-wearable/hearing device 800 in accordance with any of the embodiments disclosed herein. The hearing device 800 includes a housing 802 configured to be worn in, on, or about an ear of a wearer. The hearing device 800 shown in FIG. 8 can represent a single hearing device configured for monaural or single-ear operation or one of a pair of hearing devices configured for binaural or dual-ear operation. Where two devices are used, they may be functionally equivalent, e.g., perform the same operations as least as it relates to sound processing. Functionally equivalent devices may still operate differently, e.g., having different physical form for left/right sides, having different ear canal fittings, having different sound processing settings to deal with ear-specific (left or right) pathologies, etc.

The hearing device 800 shown in FIG. 8 includes a housing 802 within or on which various components are situated or supported. The housing 802 can be configured for deployment on a wearer's ear (e.g., a behind-the-car device housing), within an car canal of the wearer's ear (e.g., an in-the-car, in-the-canal, invisible-in-canal, or completely-in-the-canal device housing) or both on and in a wearer's ear (e.g., a receiver-in-canal or receiver-in-the-car device housing).

The hearing device 800 includes a processor 820 operatively coupled to a main memory 822 and a non-volatile memory 823. The processor 820 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 820 can include or be operatively coupled to main memory 822, such as RAM (e.g., DRAM, SRAM). The processor 820 can include or be operatively coupled to non-volatile (persistent) memory 823, such as ROM, EPROM, EEPROM or flash memory. As will be described in detail hereinbelow, the non-volatile memory 823 is configured to store instructions (e.g., in module 838) that provide functionality described elsewhere herein.

The hearing device 800 includes an audio processing facility (also referred to as an audio processor circuit) operably coupled to, or incorporating, the processor 820. The audio processing facility includes audio signal processing circuitry (e.g., analog front-end, analog-to-digital converter, digital-to-analog converter, DSP, and various analog and digital filters), a microphone arrangement 830, and a receiver 832 (e.g., acoustic/vibration transducer, loudspeaker, receiver, bone conduction transducer, motor actuator). The microphone arrangement 830 can include two or more discrete microphones or a microphone array(s) (e.g., configured for microphone array beamforming). Each of the microphones of the microphone arrangement 830 can be situated at different locations of the housing 802. It is understood that the term microphone used herein can refer to a single microphone or multiple microphones unless specified otherwise.

The receiver 832 produces amplified sound inside of the car canal. For purposes of this disclosure, “amplified” sound refers to electronically reproduced sound, which typically involves the use of an amplifier/driver to drive the receiver 832. Amplified sound does not necessarily imply an increase in sound pressure level of ambient sounds relative to what would be experienced with the hearing device removed. In some cases, the amplified sound may result in an overall sound pressure level similar to ambient, e.g., where an equalization curve is applied to affect a small frequency range. In other cases, amplified sound can reduce the sound pressure level in the ear, e.g., via active noise cancellation.

The hearing device 800 may also include a user control interface 827 operatively coupled to the processor 820. The user control interface 827 is configured to receive an input from the wearer of the hearing device 800. The input from the wearer can be any type of user input, such as a touch input, a gesture input, and/or a voice input. The user control interface 827 may be configured to receive an input from the wearer of the hearing device 800.

The hearing device 800 also includes a receiver-identifying, ML model 838 operable via the processor 820. The module 838 can be implemented in software, hardware (e.g., specialized neural network logic circuitry, general purpose processor), or a combination of hardware and software. During operation of the hearing device 800, the ML module 838 can be used to identify a classification of the receiver 832 by measuring electrical characteristics of the hardware, as indicated by hardware interface 839. The processor 820 initiates the classification process by sending a signal (e.g., test tone, ambient sound) to the receiver 832 and measuring the effects via the hardware interface 839.

The hearing device may include other sensors, such as an IMU 834 to determine an operating context of the hearing device 800, e.g., in-ear, out-of-car, etc., which can affect how the sound is analyzed and processed. The IMU 834 can also be used to provide inputs to the ML model 838, such as determining low frequencies via accelerometers, detecting system disturbances, etc.

The hearing device 800 can include one or more communication devices 836. For example, the one or more communication devices 836 can include one or more radios coupled to one or more antenna arrangements that conform to an IEEE 802.8 (e.g., Wi-Fi®) or Bluetooth® (e.g., BLE, Bluetooth® 4.2, 5.0, 5.1, 5.2 or later) specification, for example. In addition, or alternatively, the hearing device 800 can include a near-field magnetic induction (NFMI) sensor (e.g., an NFMI transceiver coupled to a magnetic antenna) for effecting short-range communications (e.g., car-to-car communications, car-to-kiosk communications). The communications device 836 may also include wired communications, e.g., universal serial bus (USB) and the like.

The communication device 836 is operable to allow the hearing device 800 to communicate with an external computing device 804, e.g., a mobile device 805 such as smartphone, laptop computer, table, etc. The external computing device 804 may include a user device and/or a device usable by a clinician in a clinical setting, such as a desktop computer, test apparatus, etc. The external computing device 804 may include a second hearing device 809, e.g. part of a pair of corresponding devices for both ears of the user. The external computing device 804 may also include a charging case 811.

The external computing device 804 includes a communications device 806 that is compatible with the communications device 836 for point-to-point or network communications. The external computing device 804 includes its own processor 808 and memory 810, the latter which may encompass both volatile and non-volatile memory. A user interface 807 facilitates interactions between the external computing device 804 and the hearing device 800, including access to settings that affect the ML model 838. The user interface 807 may, for example, allow a user check on the automatic receiver classification, e.g., compare the machine-identification with a physical identification (e.g., code, category, or model number printed on the device).

The hearing device 800 also includes a power source, which can be a conventional battery, a rechargeable battery (e.g., a lithium-ion battery), or a power source comprising a supercapacitor. In the embodiment shown in FIG. 8, the hearing device 800 includes a rechargeable power source 824 which is operably coupled to power management circuitry for supplying power to various components of the hearing device 800. The rechargeable power source 824 is coupled to charging circuitry 826. The charging circuitry 826 is electrically coupled to charging contacts on the housing 802 which are configured to electrically couple to corresponding charging contacts of a charger 811 when the hearing device 800 is placed in the charger 811.

The term ‘hearing device’ of the present disclosure may refer to a wide variety of car-level electronic devices that can aid a person with or without impaired hearing. This includes devices that can produce processed sound for persons with normal hearing, such as noise addition/cancellation to treat misophonia, or wireless earbuds for electronic sound playback. Hearing devices include, but are not limited to, behind-the-car (BTE), in-the-car (ITE), in-the-canal (ITC), invisible-in-canal (IIC), receiver-in-canal (RIC), receiver-in-the-car (RITE) or completely-in-the-canal (CIC) type hearing devices or some combination of the above. Throughout this disclosure, reference is made to a “hearing device” or “car-wearable device,” which is understood to refer to a system comprising a single left car.

This document discloses numerous example embodiments, including but not limited to the following:

Example 1 is an car-wearable device, comprising: a receiver that outputs sound into an car canal of a user in response to an electrical input signal; one or more electrical components separate from and electrically coupled to the receiver; and a processor operably coupled to the receiver and the one or more electrical components and configured to perform a measurement process comprising: sending an audio input signal to the receiver; measuring a set of frequency dependent electrical characteristics of the one or more electrical components in response to the audio input signal; inputting the set of frequency dependent electrical characteristics into a machine learning model to determine an output; determining a classification of the receiver based on the output of the machine learning model; and using the classification of the receiver to set an operational parameter of the car-wearable device.

Example 2 includes the car-wearable device of example 1, wherein the audio input comprises a test tone or signal. Example 3 includes the car-wearable device of example 1 or 2, wherein the audio input comprises ambient sound. Example 4 includes the car-wearable device of any preceding example, wherein the one or more electrical components comprise one or both of a battery and a power management circuit. Example 5 includes the car-wearable device of example 4, wherein the set of electrical characteristics comprises a voltage of the battery. Example 6 includes the car-wearable device of example 4 or 5, wherein the set of electrical characteristics comprises a discharge current of the battery.

Example 7 includes the car-wearable device of any preceding example, wherein the one or more electrical components comprise one or more microphones, and wherein the set of electrical characteristics comprises respective sound pressure levels of the one or more microphones. Example 8 includes the car-wearable device of any preceding example, wherein the operational parameter comprises one or more of receiver gain and output compression limiting.

Example 9 includes the ear-wearable device of any preceding example, wherein the measurement process is performed outside the ear canal of the user. Example 10 includes the ear-wearable device of example 9, wherein the processor is further configured to detect that the ear-wearable device is in a charging apparatus outside the ear of the user and perform the measurement process in response thereto. Example 11 includes the ear-wearable device of example 10, wherein the measurement process further comprises disabling a charging path between the ear-wearable device and the charging apparatus during the measurement process.

Example 12 includes the ear-wearable device of example 9, 10, or 11, wherein after the measurement process is complete and the ear-wearable device is in the ear canal of the user, measuring a sound pressure level of sound received an inward facing microphone of the ear-wearable device to validate the classification of the receiver.

Example 13 includes the ear-wearable device of any preceding example, wherein the machine learning model comprises a multilayer, feedforward, neural network. Example 14 includes the ear-wearable device of any one of claims 1-12, wherein the machine learning model comprises one or more of: a logistic regression, K-nearest neighbors, support vector machine (SVM), Kernal SVM, naïve Bayes, and decision tree classification.

Example 15 includes the ear-wearable device of any preceding example, wherein the classification of the receiver comprises one or more of a unique identifier of a class of the receiver, a model number of the receiver, a version of the receiver, and a left/right side indicator. Example 16 includes the ear-wearable device of any preceding example, wherein the classification of the receiver is based on amount of nominal gain to achieve a reference output from the receiver. Example 17 includes the ear-wearable device of any preceding example, wherein the processor is further configured to load the machine learning model into a memory of the ear-wearable device from an external user device before the measurement process. Example 18 includes the ear-wearable device of example 17, wherein the processor is further configured to delete the machine learning model from memory after the measurement process, wherein the classification of the receiver is stored into the memory as part of the measurement process and remains in the memory after the measurement process.

Example 19 is a method of processing sound in an car-wearable device, comprising: sending an audio input signal to a receiver of the car-wearable device; measuring a set of frequency dependent electrical characteristics of one or more electrical components in response to the audio input signal, the one or more electrical components being separate from and electrically coupled to the receiver; inputting the set of frequency dependent electrical characteristics into a machine learning model to determine an output; determining a classification of the receiver based on the output of the machine learning model; and using the classification of the receiver to set an operational parameter of the car-wearable device.

Example 20 includes the method of example 19, wherein the measurement process is performed outside an car canal of a user. Example 21 includes the method of example 20, further comprising detecting that the car-wearable device is in a charging apparatus outside the car of the user and perform the measurement process in response thereto. Example 22 includes the method of example 21, wherein the measurement process further comprises disabling a charging path between the car-wearable device and the charging apparatus during the measurement process. Example 23 includes the method of any one of examples 20-22, wherein after the measurement process is complete and the car-wearable device is in the car of the user, measuring a sound pressure level of sound received an inward facing microphone of the car-wearable device to validate the classification of the receiver.

Example 24 includes the method of any preceding method example, further comprising load the machine learning model into a memory of the car-wearable device from an external user device before the measurement process. Example 25 includes the method of example 24, further comprising deleting the machine learning model from memory after the measurement process, wherein the classification of the receiver is stored into the memory as part of the measurement process and remains in the memory after the measurement process.

Example 25 is a method of training a machine learning model for using in an car-wearable device, comprising: collecting training data from a plurality of device configurations comprising equivalent ear-wearable devices that employ different receivers, the collecting of the training data comprising, for each selected device configuration from the plurality of device configurations: sending test audio to a receiver of the selected device configuration; measuring a set of electrical characteristics of one or more electrical components of the selected device configuration at a corresponding set of frequencies in response to the test audio, the one or more electrical components separate from and electrically coupled to the receiver; forming an ordered pair comprising: the set of electrical characteristics; and a classification of the receiver; and adding the ordered pair to the training set; and training the machine learning model with the training set to predict an individual receiver classification based on an individual set of electrical characteristics measured from a fielded car-wearable device.

Example 27 includes the method of example 26, wherein the machine learning model comprises a multilayer, feedforward, neural network. Example 28 includes the method of example 26, wherein the machine learning model comprises one or more of: a logistic regression, K-nearest neighbors, support vector machine (SVM), kernel SVM, naïve Bayes, and decision tree classification.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification may be understood as being modified either by the term “exactly” or “about.” Accordingly, unless indicated to the contrary, the numerical parameters set forth in the foregoing specification are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g., 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

1. An ear-wearable device, comprising:
a receiver that outputs sound into an ear canal of a user in response to an electrical input signal;
one or more electrical components separate from and electrically coupled to the receiver; and
a processor operably coupled to the receiver and the one or more electrical components and configured to perform a measurement process comprising:
sending an audio input signal to the receiver;
measuring a set of frequency dependent electrical characteristics of the one or more electrical components in response to the audio input signal;
inputting the set of frequency dependent electrical characteristics into a machine learning model to determine an output;
determining a classification of the receiver based on the output of the machine learning model; and
using the classification of the receiver to set an operational parameter of the ear-wearable device.

2. The ear-wearable device of claim 1, wherein the audio input comprises at least one of a test tone, signal, or ambient sound.

3. The ear-wearable device of claim 1, wherein the one or more electrical components comprise one or both of a battery and a power management circuit, wherein the set of electrical characteristics comprises at least one of a voltage of the battery or a discharge current of the battery.

4. The ear-wearable device of claim 1, wherein the one or more electrical components comprise one or more microphones, and wherein the set of electrical characteristics comprises respective sound pressure levels of the one or more microphones.

5. The ear-wearable device of claim 1, wherein the operational parameter comprises one or more of receiver gain and output compression limiting.

6. The ear-wearable device of claim 1, wherein the measurement process is performed outside the ear canal of the user, wherein the processor is further configured to detect that the ear-wearable device is in a charging apparatus outside the ear of the user and perform the measurement process in response thereto.

7. The ear-wearable device of claim 6, wherein the measurement process further comprises disabling a charging path between the ear-wearable device and the charging apparatus during the measurement process.

8. The ear-wearable device of claim 6, wherein after the measurement process is complete and the ear-wearable device is in the ear canal of the user, measuring a sound pressure level of sound received an inward facing microphone of the ear-wearable device to validate the classification of the receiver.

9. The ear-wearable device of claim 1, wherein the machine learning model comprises one or more of: a multilayer, feedforward, neural network; a logistic regression; K-nearest neighbors; support vector machine (SVM); Kernal SVM; naïve Bayes; and decision tree classification.

10. The ear-wearable device of claim 1, wherein the classification of the receiver comprises one or more of a unique identifier of a class of the receiver, a model number of the receiver, a version of the receiver, and a left/right side indicator.

11. The ear-wearable device of claim 1, wherein the classification of the receiver is based on amount of nominal gain to achieve a reference output from the receiver.

12. The ear-wearable device of claim 1, wherein the processor is further configured to load the machine learning model into a memory of the ear-wearable device from an external user device before the measurement process.

13. The ear-wearable device of claim 12, wherein the processor is further configured to delete the machine learning model from memory after the measurement process, wherein the classification of the receiver is stored into the memory as part of the measurement process and remains in the memory after the measurement process.

14. A method of processing sound in an ear-wearable device, comprising:
sending an audio input signal to a receiver of the ear-wearable device;
measuring a set of frequency dependent electrical characteristics of one or more electrical components in response to the audio input signal, the one or more electrical components being separate from and electrically coupled to the receiver;
inputting the set of frequency dependent electrical characteristics into a machine learning model to determine an output;
determining a classification of the receiver based on the output of the machine learning model; and
using the classification of the receiver to set an operational parameter of the ear-wearable device.

15. The method of claim 14, wherein the measurement process is performed outside an ear canal of a user, wherein the method further comprises detecting that the ear-wearable device is in a charging apparatus outside the ear of the user and perform the measurement process in response thereto.

16. The method of claim 15, wherein the measurement process further comprises disabling a charging path between the ear-wearable device and the charging apparatus during the measurement process.

17. The method of claim 15, wherein after the measurement process is complete and the ear-wearable device is in the ear of the user, measuring a sound pressure level of sound received an inward facing microphone of the ear-wearable device to validate the classification of the receiver.

18. The method of claim 14, further comprising:
loading the machine learning model into a memory of the ear-wearable device from an external user device before the measurement process; and
deleting the machine learning model from memory after the measurement process, wherein the classification of the receiver is stored into the memory as part of the measurement process and remains in the memory after the measurement process.

19. A method of training a machine learning model for using in an ear-wearable device, comprising:
collecting training data from a plurality of device configurations comprising equivalent ear-wearable devices that employ different receivers, the collecting of the training data comprising, for each selected device configuration from the plurality of device configurations:
sending test audio to a receiver of the selected device configuration;
measuring a set of electrical characteristics of one or more electrical components of the selected device configuration at a corresponding set of frequencies in response to the test audio, the one or more electrical components separate from and electrically coupled to the receiver;
forming an ordered pair comprising: the set of electrical characteristics; and a classification of the receiver; and
adding the ordered pair to the training set; and
training the machine learning model with the training set to predict an individual receiver classification based on an individual set of electrical characteristics measured from a fielded ear-wearable device.

20. The method of claim 19, wherein the machine learning model comprises one or more of: a multilayer, feedforward, neural network; a logistic regression; K-nearest neighbors; support vector machine (SVM); kernel SVM; naïve Bayes; and decision tree classification.
